(19) United States
(12) Patent Application Publication
(10) Pub. No.: US 2024/0317913 A1
(43) Pub. Date: Sep. 26, 2024

(54) HIGH HEAT ACRYLIC COPOLYMERS CONTAINING A FUNCTIONAL COMONOMER AS BINDERS FOR BATTERIES

(71) Applicant: Trinseo Europe GmbH, Pfaeffikon (CH)

(72) Inventors: Jiaxin Jason Ge, Audubon, PA (US); Zhengjun David Zhu, Shanghai (CN)

(73) Assignee: Trinseo Europe GmbH, Pfaeffikon (CH)

(21) Appl. No.: 18/383,277

(22) PCT Filed: Apr. 29, 2022
(86) PCT No.: PCT/US2022/026966

§ 371 Date: Oct. 24, 2023

Related U.S. Application Data
(60) Provisional application No. 63/181,545, filed on Apr. 29, 2021.

(51) Int. Cl. C08F 220/14; H01M 4/62

(52) U.S. Cl. CPC C08F 220/14; H01M 4/623

(57) ABSTRACT

The invention relates to an acrylic copolymer composition, wherein said copolymer comprises one or more (meth)acrylic monomer units and hydrophilic 2-carboxyethyl acrylate (CEA) and/or (meth)acrylic acid (MAA or AA) hydrophilic monomer units. The copolymer may be an amphiphilic terpolymer further including hydrophobic monomer units, such as tert-butyl cyclohexyl (meth)acrylate, isobornyl methyl acrylate (IBOMA) and isobornyl acrylate (IBOA). The copolymers are designed to meet the requirements of high heat resistance, improved bonding adhesion, and exhibit excellent mechanical properties, along with excellent chemical resistance. The copolymers of the invention possess a high Tg along with sufficiently high molecular weight for applications in battery cathode binders, coatings, composites, glass-/carbon-fiber re-enforced composites, water filtration membranes, optical lenses, extruded films, laminates, and (co-)extruded sheets/profiles.

### CROSS-REFERENCE TO RELATED APPLICATIONS

This application is a national phase of International Application No. PCT/US2022/026966, filed Apr. 29, 2022, which claims the benefit of priority of U.S. Provisional Application No. 63/181,545, filed Apr. 29, 2021, the contents of each of which is incorporated herein by reference in its entirety for all purposes.

### FIELD OF THE INVENTION

The invention relates to a copolymer comprising one or more (meth)acrylic monomer units and hydrophilic 2-carboxyethyl acrylate (CEA) and/or (meth)acrylic acid (MAA or AA) hydrophilic monomer units. The copolymer may be an amphiphilic terpolymer further including one or more hydrophobic monomer units, such as tert-butyl cyclohexyl (meth)acrylate, isobornyl methyl acrylate (IBOMA) isobornyl acrylate (IBOA), and 3,3,5-trimethyl cyclohexyl (meth)acrylate. The copolymers are designed to meet the requirements of high heat resistance, improved bonding adhesion, and excellent mechanical properties, along with excellent UV resistance. The copolymers of the invention possess high Tg of 110-150° C. along with sufficiently high molecular weight for applications, such as in battery binders (e.g., Li-ion battery cathode binders), separator coatings, composites, glass-/carbon-fiber re-enforced composites, water filtration membranes, optical lenses, extruded films, laminates, and (co-) extruded sheets/profiles.

### BACKGROUND OF THE INVENTION

High molecular weight (MW) polyvinylidene fluoride (PVDF)-containing materials are excellent candidates for battery binders, in particular battery cathode binders. However, the bonding adhesion from PVDF-containing materials still needs to be improved. Acrylic polymer-containing materials may also be used as binders, but standard acrylic copolymers are not well suited for blending with PVDF-containing materials to improve the bonding adhesion for use in battery binder such as battery cathode binders, and further suffer from poor electrical stability that does not satisfy the requirements for high performance Li-ion batteries.

High Tg hydrophobic acrylic copolymers, such as those described in WO 2020/20108, exhibit high heat resistance, high light transmission, low haze, low moisture uptake, excellent environmental stability, excellent high temperature thermal stability, and excellent mechanical properties, along with excellent UV resistance. However, these polymers lack the high bonding adhesion and environmental stability needed in many applications.

Surprisingly, it has now been found that physical blends of functional PMMA copolymer or terpolymers with PVDF polymers provide cost-effective battery binders, in particular cost-effective battery cathode binders for Li ion batteries, that also exhibit improved bonding adhesion, high heat resistance (high Tg) and sufficiently high environmental stability. The novel copolymers of the invention are also useful for coatings, films, sheets, and parts/articles with a light transmission of >91% and haze <2%.

### SUMMARY OF THE INVENTION

The invention relates to a copolymer composition comprising an acrylic copolymer having one or more (meth)acrylic monomer units and hydrophilic 2-carboxyethyl acrylate (CEA) monomer units. The CEA monomer units make up about 0.5 to 10 weight percent of the acrylic copolymer. Preferably the CEA-containing acrylic copolymer has a high Tg of at least 110-150° C. along with sufficiently high molecular weight higher than 65,000 g/mole, preferably higher than 120,000 g/mole. The (meth)acrylic monomer units comprise from 75 to 99 wt % of the acrylic copolymer. Preferably, the acrylic copolymer comprises from 0.1 to 10 wt percent of one or more (alkyl)₁₋₄ (meth)acrylate units as part of the one or more (meth)acrylic monomer units.

The acrylic copolymer may be blended with typical additives, and in a preferred embodiment impact modifiers are present at from 5 to 50 wt percent of the total acrylic copolymer composition.

Compatible polymers, such as polyvinylidene fluoride can be added to the acrylic copolymer composition.

Due to its high molecular weight and hydrophilic functionality, the acrylic copolymer is heat resistant and has improved adhesive properties, making it useful for applications such as battery binders, separator coating, composites, glass-/carbon-fiber re-enforced composites, water filtration membranes, optical lenses, extruded films, laminates, (co-)extruded sheets/profiles, automotive front lenses, lighting pipes, optical protection films in reflective signage, and home appliances.

### DETAILED DESCRIPTION OF THE INVENTION

The invention relates to the incorporation of hydrophilic 2-carboxyethyl acrylate (CEA) into high heat acrylic polymers, to produce useful new functional, high Tg copolymers. Terpolymers are formed by additionally including a high Tg hydrophobic monomer, such as tert-butyl cyclohexyl (meth)acrylate, isobornyl methyl acrylate (IBOMA) isobornyl acrylate (IBOA), 3,3,5-trimethyl cyclohexyl (meth)acrylate, and others.

As used herein, “copolymer” refers to a polymer having two or more different monomer units, including copolymers, and polymers with three or more different monomers, such as terpolymers and tetrapolymers.

As used herein, “polymer” refers to both homopolymers and copolymers. Polymers may be straight chain, branched, star, comb, block, or any other structure. The polymers may be homogeneous, heterogeneous, and may have a gradient distribution of co-monomer units.

As used herein, “amphiphilic polymers” are long chain molecules that simultaneously contain hydrophobic and hydrophilic components.

All references cited are incorporated herein by reference. As used herein, unless otherwise described, percent shall mean weight percent. Molecular weight is a weight average molecular weight as measured by GPC. In cases where the polymer contains cross-linking, and GPC cannot be applied due to an insoluble polymer fraction, a soluble fraction/gel fraction or soluble faction molecular weight after extraction from gel is used.

As used herein, “(meth)acrylic” or “(meth)acrylate” denotes both an acrylate and a methacrylate and mixtures thereof.

As used herein, the term “impact modifier” refers to additives that increase the durability (impact resistance, ductility) of a resin, and may include block copolymers, graft copolymers, and core-shell particles. In the case of block copolymers or graft copolymers, the impact modifier additive phase separates from the polymer matrix into elastomeric nano-domains that may adopt a number of morphologies, including spherical and worm-like. The characteristic size as of the elastomeric nano-domains as determined by Transmission Electron Microscopy (TEM) is no greater than 500 nm. In the case of core/shell particles, the impact modifier additives are spherical particles with a number average particle diameter as determined by laser diffraction particle size analysis of less than 600 nm. Core/shell impact modifiers are multi-stage, sequentially produced polymeric particles having a core/shell particle structure of at least two layers. Preferentially, the core shell-modifier comprises three layers made of a hard core layer, one or more intermediate elastomeric layers, and a hard shell layer.

### Hydrophilic Monomer

The high Tg, or high heat, copolymers of the invention include one or more acrylic monomers copolymerized with a specific high Tg comonomer: 2-carboxyethyl acrylate (CEA). Other acrylate monomers, such as meth acrylic acid, may be present in addition to the CEA.

The CEA monomer (n=1) or oligomer (n=0, 2 or 3) has the chemical formula:

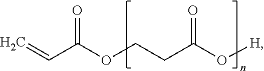

where n=0, 1, 2, or 3

In an embodiment shown in the table below, the CEA monomer or oligomer contains 36.5 mol % CEA monomer (n=1), 36.5 mol % CEA oligomer where n=0, 10 mol % oligomer where n=2, and 17 mol % CEA oligomer where n=3.

Mol. % by ¹H NMR

| Description | n = 0 | n = 1 | n = 2 | n = 3 |
|---|---|---|---|---|
| CEA | 36.5 | 36.5 | 10 | 17 |

The CEA monomer or oligomer is present in the acrylic copolymer or terpolymer at a level of from 0.5 wt. % to 10 wt. % and preferably from 1 to 7 weight percent, based on the total polymer weight.

### Acrylic Monomer

The CEA hydrophilic monomer is copolymerized with one or more other monomers. In a preferred embodiment of the invention the copolymer contains at least 51 weight percent of methylmethacrylate monomer units, preferably at least 70 weight percent and more preferably at least 80 weight percent methylmethacrylate monomer units based on the total weight of the copolymer.

The copolymers of the invention, in addition to the CEA and methyl methacrylate, may include 0 to 25, preferably 1 to 15, and more preferably from 1 to 10 weight percent of other acrylate and methacrylate monomers or other ethylenically unsaturated monomers, included but not limited to, styrene, alpha methyl styrene, acrylonitrile, and crosslinkers at low levels may also be present in the monomer mixture. Suitable acrylate and methacrylate comonomers include, but are not limited to, methyl acrylate, ethyl acrylate and ethyl methacrylate, butyl acrylate and butyl methacrylate, iso-octyl methacrylate and iso-octyl acrylate, lauryl acrylate and lauryl methacrylate, stearyl acrylate and stearyl methacrylate, isobornyl acrylate and isobornyl methacrylate, methoxy ethyl acrylate and methoxy methacrylate, 2-ethoxy ethyl acrylate and 2-ethoxy ethyl methacrylate, and dimethylamino ethyl acrylate and dimethylamino ethyl methacrylate monomers. (Meth) acrylic acids such as methacrylic acid and acrylic acid can be useful for the monomer mixture. In addition to carboxyl functionality, other functionality can be added to the high molecular weight acrylic process aid through functional comonomers, including epoxy (such as glycidyl methacrylate), hydroxyl, and anhydride functional groups. Functional monomer units (monomer units having a functional group) can be present at up to 50 weight percent of the acrylic polymer, preferably up to 30 weight percent.

In a preferred embodiment, the acrylic copolymer has a high Tg of greater than 110° C., preferably 115° C., more preferably greater than 120° C., greater than 125° C., greater than 130° C., greater than 135° C., and even greater than 140° C. In addition to the CEA, other high Tg monomers may optionally be present at levels of 0 to 25 weight percent, and more preferably from 0 to 10 weight percent. The other high Tg monomers may be hydrophilic, hydrophobic or have a neutral character, and include, but are not limited to methacrylic acid, acrylic acid, itaconic acid, alpha methyl styrene, maleic anhydride, maleimide, isobornyl methacrylate, norbornyl methacrylate, t-butyl methacrylate, cyclohexyl methacrylate, acrylamide and methacrylamide.

### Hydrophobic Monomer

In a preferred embodiment, the acrylic high Tg copolymer of the invention is an amphiphilic terpolymer having CEA, methyl methacrylate, and at least one high Tg hydrophobic monomer. Preferably, the hydrophobic monomer units comprise from 0.2 to 10 weight percent, more preferably from 0.5 to 5 weight percent of the acrylic copolymer.

As used herein, “hydrophobic” means that a 25 weight percent solution of the copolymer dissolved in toluene, when heated with stirring to 65° C. to form opaque viscous gels, and then is allowed to cool to room temperature (23° C.), is optically clear, along with some soft gels. Upon heating to 65° C., physical gelation occurs throughout the whole “solution” while the viscous “solution” becomes opaque, resulting in a viscous jelly-like material due to two phase separation of hydrophilic copolymers in hydrophobic solvent (such as toluene) at a high temperature (65° C.). In addition, it is a physically reversible process. The high Tg, hydrophobic monomers of the invention are useful used to reduce the water absorption, moisture sensitivity and improve environmental stability.

Useful high Tg hydrophobic monomers include, but are not limited to tert-butyl cyclohexyl (meth)acrylate, 3,3,5-trimethyl cyclohexyl (meth)acrylate, isobornyl methyl acrylate (IBOMA), and isobornyl acrylate (IBOA).

Tert-butyl cyclohexyl (meth)acrylate has the structural formulas below:

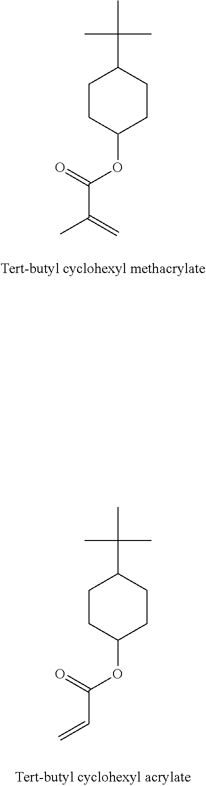 [SMILES: C=C(C)C(=O)OC1CCC(C(C)(C)C)CC1 ; C=CC(=O)OC1CCC(C(C)(C)C)CC1]

The monomer is a mixture of the cis- and trans-forms, having a trans/cis ratio of between 2/98 to 90/10, preferably 30/70 to 85/15, preferably 40/60 to 80/20, and more preferably 50/50 to 75/25.

The level of tert-butyl cyclohexyl (meth)acrylate in the final copolymer generally ranges from 0.2 to 20 weight percent, and more preferably from 0.5 to 10 weight percent of tert-butyl cyclohexyl methacrylate is used in the copolymer. It has been found that as little as 1 weight percent, and even 0.5 weight percent of tert-butyl cyclohexyl methacrylate, provides a copolymer having a hydrophobic character. The Tg of the copolymer of the invention is preferably from 116° C. to 140° C.

3,3,5-Trimethyl cyclohexyl(meth)acrylate has the structural formulas below. The monomer is a mixture of the cis- and trans-forms.

The level of 3,3,5-trimethyl cyclohexyl(meth)acrylate in the final copolymer generally ranges from 0.2 to 20 weight percent, and more preferably from 0.5 to 10 weight percent of tert-butyl cyclohexyl methacrylate is used in the copolymer. It has been found that as little as 1 weight percent, and even 0.5 weight percent of tert-butyl cyclohexyl methacrylate, provides a copolymer having a hydrophobic character.

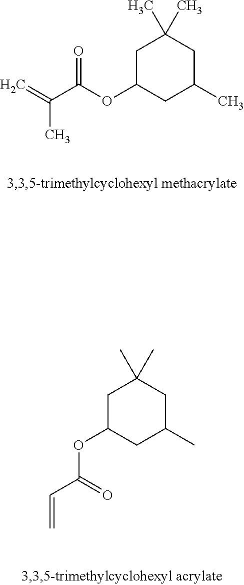

The level of tert-butyl cyclohexyl methacrylate or 3,3,5-trimethyl cyclohexyl methacrylate in the final copolymer generally ranges from 0.2 to 20 weight percent, and more preferably from 0.5 to 10 weight percent based on the total monomer units in the copolymer. It has been found that as little as 1 weight percent, and even 0.5 weight percent of tert-butyl cyclohexyl methacrylate, provides a copolymer having a hydrophobic character. The Tg of the copolymer of the invention is preferably from 116° C. to 135° C.

### Synthesis

The acrylic copolymers of the invention are obtained through melt polymerization (not limited to), solution polymerization, emulsion polymerization, and suspension polymerization.

### Additives

The copolymers of the invention can be blended with typical additives used in thermoplastics. These include, but are not limited to fillers, surface modifying additives, antioxidants, UV screens, processing aids, fibers, lubricant agents, heat stabilizers, antioxidants, flame retardants, synergists, impact modifiers, pigments and other coloring agents, lithium nickel cobalt manganese oxide (LiNiCoMnO2), carbon black, graphite sheets, graphite flakes and radical scavenging agents.

Other polymer additives could include polycarbonates, polyurethanes, polysulfones, polyamides, polyolefin including copolymers and terpolymers based on these polymers, and including linear, branched, block, and grafted polymer structures. Examples of matting agents include, but are not limited to, cross-linked polymer particles of various geometries. The amount of filler and additives included in the polymer compositions of each layer may vary from about 0.01% to about 70% of the combined weight of polymer, additives and filler. Generally, amounts from about 5% to about 45%, from about 10% to about 40%, are included.

### Impact Modifiers

The composition of the invention may be impact-modified. Impact modifiers useful in the invention must be miscible, semi-miscible or compatible with the copolymer matrix, to ensure a homogeneous distribution of the impact modifier in the matrix copolymer. Useful impact modifiers include block copolymers, graft copolymers, and core/shell impact modifiers. Preferably, acrylic impact modifiers, acrylic silicone impact modifiers or methyl methacrylate butadiene styrene (MBS) impact modifiers are used. In one embodiment, for compositions with high optical clarity, the impact modifiers are preferably refractive-index matched to the matrix polymer. By refractive index matched means the difference in refractive index between the impact modifiers and matrix copolymer is plus or minus 0.02 or less, preferably less than 0.01, and most preferably less than 0.05.

In a preferred embodiment, the impact modifier comprises at least 50 weight percent of acrylic monomer units. The impact modifier may be present at a level of from 5 to 60, and more preferably from 10 to 50 weight percent, based on the total layer of matrix polymer and all additives. In yet another preferred embodiment the impact modifiers comprise from 5 wt. % to 50 wt. % of said acrylic copolymer composition. The level of impact modifier can be adjusted to meet the toughness needs for the end use of the composition. Core-shell impact modifiers are multi-stage, sequentially-produced polymer having a core/shell particle structure of at least two layers. In one embodiment, the core-shell impact modifier has a soft (elastomeric) core, and a hard shell (greater than a Tg of 20° C.). Preferentially, the core-shell modifier comprises at least three layers made of a hard core layer, one or more intermediate elastomeric layers, and a hard shell layer. Preferably the impact modifier is a core-shell structure, in which the shell contains at least 50 weight percent of methyl methacrylate monomer units. In one embodiment, the core-shell impact modifier has a hard core (with a Tg greater than 30° C., and more preferably greater than 50° C.).

Nanostrength® block copolymers from Arkema which self-assemble on a nano-scale, provide for efficient impact modification, and have less of a detrimental effect on the viscosity and optical clarity of the composition. These block copolymers can be used as the sole impact modifier at levels of 3 to 60 weight percent, and preferably from 5 to 45 weight percent. They can also be efficiently used in combination with one or more types of core-shell impact modifiers. For example, 2 to 20 weight percent, and preferably 3 to 15 weight percent of Nanostrength® block copolymers, may be combined with 10 to 40 weight percent, and preferably 15 to 35 weight percent of traditional core-shell modifiers, and preferable hard core, core shell impact modifiers.

The impact modifiers of the invention can be melt compounded with the copolymer of the invention, by means known in the art.

### Antioxidants

In one embodiment, selected antioxidants may be used to improve the thermal stability of the resins at high temperature such as 240-270° C. and reduce the yellowing at high temperature. The loading of the antioxidants in the final resin(s) formulations are at the levels of approximately 50 ppm to 3500 ppm, preferably about 100 ppm to about 2500 ppm based on the total weight of the composition. Non-limiting examples of useful antioxidants include sterically hindered phenols, organophosphites hindered amine light stabilizers (HALS), benzotriazoles, triazines, benzophenones, and cyanoacrylates.

Polymers Compatible with the Acrylic Copolymer

The acrylic copolymer composition of the invention may further comprise one or more polymers compatible with said acrylic copolymer.

In one embodiment, the copolymers comprising CEA are suitable to be blended with one or more polyvinylidene fluoride (PVDF) polymers, preferably high molecular weight PVDF polymers, for use in battery applications. Said polyvinylidene fluoride (PVDF) polymers may be homopolymers or copolymers. In a preferred embodiment, the copolymers of the invention may be blended with PVDF polymers such as KYNARR HSV 900 battery grade resin from Arkema or Solef® 5130 from Solvay for use as battery binders such as battery cathode binders. This blend results in improved bonding adhesion. Without wanting to be bound by any particular theory, the compatibility between acrylic copolymer and the polyvinylidene fluoride (PVDF) polymers may be achieved through dipole-dipole interactions or hydrogen bonding.

Typically, a blend of the acrylic copolymer composition with the polyvinylidene fluoride polymer, preferably with a high-molecular weight polyvinylidene polymer, comprises between 2 wt. % to 25 wt % of the acrylic copolymer, and more preferably 5 wt % to 20 wt. %.

In one embodiment, the acrylic copolymer composition of the invention comprises an acrylic copolymer blend, preferably a PMMA blend, with one or more polyvinylidene fluoride (PVDF) polymers, preferably high molecular weight polyvinylidene fluoride (PVDF) polymers, wherein 5-25 weight percent of PVDF polymers has been replaced with acrylic copolymers, preferably with PMMA.

### Properties

The high heat acrylic copolymer compositions comprising hydrophilic 2-carboxyethyl acrylate (CEA) are designed to meet the requirement of high heat resistance, improved bonding adhesion, and excellent mechanical properties, along with excellent UV resistance. In addition, hydrophobic co-monomers in PMMA are used to reduce the water absorption, moisture sensitivity and improve environmental stability.

The weight average molecular weight of the acrylic copolymers is higher than 65,000 g/mole, preferably higher than 80,000 g/mole, more preferably higher than 100,000 g/mole, and much more preferably higher than 120,000 g/mole. The Tg value of the acrylic copolymers is higher than 110° C., preferably greater than 115° C., preferably higher than 120° C., and more preferably higher than 125° C.

Optical films, sheets and/or formed parts made of the copolymer/terpolymer of the invention possess a light transmission of higher than 91%, and optical haze of less than 2%.

### Use

The copolymers or terpolymers possess high Tg of 110-140° C., preferably from 115° C. to 135° C., more preferably from 115° C. to 130° C., and more preferably from 120° C. to 130° C., for high heat resistance, along with sufficiently high molecular weight, and are useful in many applications. These applications include, but not limited to applications in battery binders such as battery cathode binders, separator coatings, composites, glass-/carbon-fiber re-enforced composites, water filtration membranes, optical lenses, extruded films, laminates, (co-)extruded sheets/profiles, automotive front lenses, lighting pipes, optical protection films in reflective signage, and home appliance.

Impact modifier containing copolymers are useful in applications such as glass/carbon fiber reinforced composites.

Arkema's Nanostrength® block copolymers, PVDF homopolymers (such as KYNAR HSV900 PVDF), PVDF-hexafluoropropylene (HFP) copolymers, and other compatible copolymers such as pMMA-EA, and PMMA-MA may be suitable for forming new blends with high heat pMMA acrylic resins for different applications from co-extruded profiles in building and constructions to film laminates for reflective signage to battery binders such as battery cathode binders.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The invention further relates to an article comprising an acrylic copolymer composition wherein said acrylic copolymer comprises a) one or more (meth)acrylic monomer units, b) 2-carboxyethyl acrylate (CEA) and/or (meth)acrylic acid (MAA or AA) hydrophilic monomer units, c) optionally one or more hydrophobic monomer units and d) optionally one or more hydrophilic monomer units different from b). Preferably, the acrylic copolymer composition comprised in the article is blended with a polyvinylidene fluoride polymer, preferably a high molecular weight polyvinylidene fluoride polymer. More preferably, the acrylic copolymer composition comprised in the article is blended with a high molecular weight polyvinylidene fluoride polymer, said blend preferably comprising 2 wt. % to 25 wt % of the acrylic copolymer, and more preferably 5 wt % to 20 wt. %.

Preferably, said article is selected from the group consisting of batteries, composites, glass-/carbon-fiber re-enforced composites, water filtration membranes, optical lenses, extruded films, laminates, (co-)extruded sheets/profiles, automotive front lenses, lighting pipes, optical protection films in reflective signage, and home appliance. More preferably, said article comprising an acrylic copolymer composition is part of a binder for a battery, preferably for a binder for a cathode, and/or separator coatings in said battery, preferably a lithium ion battery.

Moreover, the invention relates to a method for improving bonding adhesion strength of a polyvinylidene fluoride polymer (PVDF), preferably a high molecular weight polyvinylidene fluoride polymer, in a battery binder, preferably a cathode battery binder, by at least 1.2 times, preferably by at least 1.3 time, more preferably by at least 1.4 times, wherein the method comprises replacing 5-25 weight percent of the PVDF with an acrylic polymer, preferably PMMA.

The invention also relates to a method for reducing slurry viscosity of a polyvinylidene fluoride polymer (PVDF), preferably a high molecular weight polyvinylidene fluoride polymer in a battery binder, preferably a cathode battery binder by at least 10%, preferably by at least 20%, wherein the method comprises replacing 5-25 weight percent of the PVDF with an acrylic polymer, preferably PMMA.

### Examples

### Testing Methods

Melt flow rate (MFR) measurement: Instron Ceast MF30 equipment was used for polymers in melt flow rate measurements. The die temperature was controlled at 230° C. while the loading cell weight was at 3.8 kg. The dried pellets were used near 20° C. below the Tg over 8 hours.

Gel permeation chromatography (GPC): Waters Alliance 2695 and Waters Differential Refractometer 2410 were used to make polymer molecular weight measurements, along with a multiple angle light scattering (MALS) detector. Columns were based on two PL Gel mixed C columns and a guard column (7.8 mm I.D.×30 cm, 5 μm). THF (HPLC grade) was selected as a solvent. Temperature was controlled at 35° C. Ten poly(methyl methacrylate) standards were used in the calibration, ranging in Mp (peak molecular weight) from 550 to 1,677,000 g/mole.

Differential scanning calorimetry (DSC): The glass transition temperatures of acrylic polymers were measured at a heating rate of 10° C./minutes in N₂ using TA instruments Q2000 DSC, during the second heating. The first heating was used to heat the sample to 170° C. at a heating rate of 10° C./minute, then, the sample was cooled down to 0° C. at a cooling rate of 10° C./minute. The sample weight was controlled at 5-10 mg.

Thermogravimetry (TGA): The thermal decomposition temperatures of acrylic polymers were measured at a heating rate of 10° C./minute in N₂ using TA instruments Q5000 TGA. The sample weight was controlled at 5-10 mg. The samples were pre-dried under a vacuum oven at 100° C. overnight.

Vicat softening temperatures: The samples were tested in Instron HV6M under 10N and 50N external forces using ASTM method D1525. The sample heating rate was controlled at the speed of 50° C./hour. The injection molded samples were annealed at ˜20 C below the Tg value for 16 hours and were kept in a desiccator oven before testing.

Total light transmission: The total light transmission was measured from film and/or plaque samples in a transmission mode using Perkin Elmer Lambda 950 with a 150 mm integrating sphere. The selected UV/Vis wavelength range was from 200 nm to 800 nm in UV/Vis region.

Haze: Optical haze of clear film and/or plaque samples was measured using BYK HazeGard Plus under ASTM method D1003.

Refractive index: Refractive index of the polymer film was measured at three different wavelengths of 402 nm, 518 nm, and 636.5 nm using an optical prism coupler Metricon 2010 from Metricon Inc while the refractive index was calculated at a selected wavelength of 589 nm.

NMR: Samples were prepared by dissolving approximately 200 mg of pellets in approximately 4 ml CDCl₃ in separate 10 mm NMR tubes for ¹³C NMR. The ¹H spectra were acquired on the Bruker AV III HD 500 (11.07 T) spectrometer with a 5 mm ¹H/¹⁹F/¹³C TXO probe at 25° C. before and after derivatization of MAA. The ¹³C spectra were acquired on the Bruker AV 400 (9.4 T) with a 10 mm BBO probe at 50° C. The CEA level was determined after derivatization with chlorotrimethyl silane (CTMS).

Tensile strength and elongation: The tensile strength, modulus and elongation of the tensile bars was evaluated using Instron Model 4202 at the crosshead speed of 5 mm/minute using ASTM D638 method after being preconditioned at 23° C./48 hours. The tensile was at 6″ in length while the width was at 0.50″. The sample thickness was at 0.125″.

Peel adhesion testing: The peel adhesion strength performance was evaluated by using Instron 3343 model and/or KD-III5 made by KQL with a 10N load cell. Peel adhesion strengths were measured in N/m. The testing coated samples were cut into 25 mm wide stripes along with 150-200 mm in length. The samples were dried in a vacuum oven at 60° C. overnight. Peel adhesion strengths for cathodes were obtained in a dry room via a 180° type peel test under ASTM D903 with a few modifications. The first modification was that the drawing rate used was changed to 150 mm/minute (vs. 25 mm/minute). The second modification was that test samples dried again prior to peel test, and the peel adhesion test was conducted. The variations in exposure to ambient moisture might have significant impact on the peel adhesion results. A typical 25 mm wide coated stripe was laminated to the alignment plate through a 410M double sided paper tape (from 3M) while a flexible aluminum foil current collector was peeled by mechanical grips.

### Example 1 (pMMA Copolymer with 2-CEA)

pMMA-CEA copolymer was made from solution polymerization in toluene at 68° C.: This example demonstrates the preparation of a high molecular weight copolymer of methyl methacrylate and 2-carboxyethyl acrylate. 94.78 parts of methyl methacrylate and 5.22 parts of 2-carboxyethyl acrylate (2-CEA from Aldrich) were charged into a reaction vessel containing 300 parts of toluene near 23° C. with a mechanical stirring speed of 380 rpm. AIBN (from Aldrich) was used as an initiator at a level of 0.241_parts. The polymerization reaction occurred at 68° C. for 6 hours. When the conversion reached >50%, the residual monomers were removed through a precipitation in methanol. Then, the solid polymer powder was dissolved in acetone at the solid content of 25 wt % and the polymer solution was precipitated in sufficient MeOH again (MeOH×6 folds/3 times). The re-precipitated white powder samples were dried at 120° C. and 180° C. in a vacuum oven for 8 hours and 16 hours, respectively. The melt flow rate (MFR) of this polymer was measured at 0.5 g/10 minutes at 230 C/3.8 kg. The refractive index of the resulting polymer was measured at 1.490 at 589 nm.

The resulting polymer was confirmed using ¹H NMR and ¹³C NMR to possess the composition of pMMA/2-carboxyethyl acrylate (n=0-3) (97.1/2.9 mol/mol). The glass transition temperature of the copolymer resin was measured to be 123° C. in N₂ using DSC at the heating rate of 10° C./minute. The weight average molecular weight Mw of the resin was measured as 123,000 g/mole using GPC and MALS along with a Mw/Mn (polydispersity) value of 1.8. The light transmission from a 120 μm film was measured to be 92.2% at 560 nm using Lambda 950 while the haze was measured to be 0.4% using a hazemeter (Haze Gard Plus from BYK).

### Example 2 (pMMA Copolymer with 2-CEA)

pMMA-CEA copolymer was made from solution polymerization in toluene at 66° C.: This example demonstrates the preparation of a high molecular weight copolymer of methyl methacrylate and 2-carboxyethyl acrylate. 92.96 parts of methyl methacrylate and 7.04 parts of 2-carboxyethyl acrylate (2-CEA from Aldrich) were charged into a reaction vessel containing 300 parts of toluene near 23° C. with a mechanical stirring speed of 370 rpm. AIBN (from Aldrich) was used as an initiator at a level of 0.234_parts. The polymerization reaction occurred at 66° C. for 7 hours. When the conversion reached >50%, the residual monomers were removed through a precipitation in methanol. Then, the solid polymer powder was dissolved in acetone at the solid content of 25 wt. % and the polymer solution was precipitated in sufficient MeOH again (MeOH×6 folds/3 times). The re-precipitated white powder samples were dried at 120° C. and 180° C. in a vacuum oven for 8 hours and 16 hours, respectively. The melt flow rate (MFR) of this polymer was measured at 0.5 g/10 minutes at 230 C/3.8 kg. The refractive index of the resulting polymer was measured at 1.490 at 589 nm.

The resulting polymer was confirmed using ¹H NMR and ¹³C NMR to possess the composition of pMMA/2-carboxyethyl acrylate (n=0-3) (96.8/3.2 mol/mol). The glass transition temperature of the copolymer resin was measured to be 123° C. in N₂ using DSC at the heating rate of 10° C./minute. The weight average molecular weight Mw of the resin was measured as 122,000 g/mole using GPC and MALS along with a Mw/Mn (polydispersity) value of 1.8. The light transmission from a 120 μm film was measured to be 92.1% at 560 nm using Lambda 950 while the haze was measured to be 0.3% using a hazemeter (Haze Gard Plus from BYK).

### Example 3 (pMMA Copolymer with 2-CEA)

pMMA-CEA copolymer was made from solution polymerization in toluene at 67° C.: This example demonstrates the preparation of a high molecular weight copolymer of methyl methacrylate and 2-carboxyethyl acrylate. 90.82 parts of methyl methacrylate and 9.18 parts of 2-carboxyethyl acrylate (2-CEA from Aldrich) were charged into a reaction vessel containing 300 parts of toluene near 23° C. with a mechanical stirring speed of 380 rpm. AIBN (from Aldrich) was used as an initiator at a level of 0.230 parts. The polymerization reaction occurred at 67° C. for 7 hours. When the conversion reached >50%, the residual monomers were removed through a precipitation in methanol. Then, the solid polymer powder was dissolved in acetone at the solid content of 25 wt % and the polymer solution was precipitated in sufficient MeOH again (MeOH×6 folds/3 times). The re-precipitated white powder samples were dried at 120° C. and 180° C. in a vacuum oven for 8 hours and 16 hours, respectively. The melt flow rate (MFR) of this polymer was measured at 0.4 g/10 minutes at 230 C/3.8 kg. The refractive index of the resulting polymer was measured at 1.489 at 589 nm.

The resulting polymer was confirmed using ¹H NMR and ¹³C NMR to possess the composition of pMMA/2-carboxyethyl acrylate (n=0-3) (94.7/5.3 w/w). The glass transition temperature of the copolymer resin was measured to be 122° C. in N₂ using DSC at the heating rate of 10° C./minute. The weight average molecular weight Mw of the resin was measured as 134,000 g/mole using GPC and MALS along with a Mw/Mn (polydispersity) value of 1.8. The light transmission from a 120 μm film was measured to be 92.1% at 560 nm using Lambda 950 while the haze was measured to be 0.5% using a hazemeter (Haze Gard Plus from BYK).

### Example 4 (pMMA Copolymer with 2-CEA and MAA)

pMMA-CEA-MAA terpolymer was made from solution polymerization in toluene at 66° C.: This example demonstrates the preparation of a high molecular weight copolymer of methyl methacrylate and 2-carboxyethyl acrylate. 94.24 parts of methyl methacrylate, 4.67 parts of 2-carboxyethyl acrylate (2-CEA from Aldrich) and 1.09 parts of methyl acrylic acid (MAA) were charged into a reaction vessel containing 300 parts toluene near 23° C. with a mechanical stirring speed of 360 rpm. AIBN (from Aldrich) was used as an initiator at a level of 0.210 parts. The polymerization reaction occurred at 66° C. for 7 hours. When the conversion reached >50%, the residual monomers were removed through a precipitation in methanol. Then, the solid polymer powder was dissolved in acetone at the solid content of 25 wt % and the polymer solution was precipitated in sufficient MeOH again (MeOH×6 folds/3 times). The re-precipitated white powder samples were dried at 120° C. and 180° C. in a vacuum oven for 8 hours and 16 hours, respectively. The melt flow rate (MFR) of this polymer was measured at 0.5 g/10 minutes at 230 C/3.8 kg. The refractive index of the resulting polymer was measured at 1.490 at 589 nm.

The resulting polymer was confirmed using ¹H NMR and ¹³C NMR to possess the composition of pMMA/2-carboxyethyl acrylate/MAA (96.5/2.5/1.0 mol/mol/mol). The glass transition temperature of the copolymer resin was measured to be 125° C. in N₂ using DSC at the heating rate of 10° C./minute. The weight average molecular weight Mw of the resin was measured as 125,000 g/mole using GPC and MALS along with a Mw/Mn (polydispersity) value of 1.9. The light transmission from a 120 μm film was measured to be 92.2% at 560 nm using Lambda 950 while the haze was measured to be 0.4% using a hazemeter (Haze Gard Plus from BYK).

### Example 5 (pMMA Copolymer with 2-CEA and Tert-Butyl Cyclohexyl Methacrylate)

The solution polymerization of PMMA-CEA-tert-butyl cyclohexyl methacrylate, an acrylic terpolymer with 2-carboxyethyl acrylate (2-CEA) and tert-butyl cyclohexyl methacrylate (SR218A from Sartomer, containing 56% trans/44% cis isomer ratio).

pMMA-CEA-tert-butyl cyclohexyl methacrylate terpolymer was made from solution polymerization in toluene at 65° C.: This example demonstrates the preparation of a high molecular weight copolymer of methyl methacrylate and 2-carboxyethyl acrylate. 93.64 parts of methyl methacrylate, 5.24 parts of 2-carboxyethyl acrylate (2-CEA from Aldrich) and 1.12 parts of tert-butyl cyclohexyl methacrylate (Sartomer) were charged into a reaction vessel containing 300 parts toluene near 23° C. with a mechanical stirring speed of 360 rpm. AIBN (from Aldrich) was used as an initiator at a level of 0.212 parts. The polymerization reaction occurred at 65° C. for 7 hours. When the conversion reached >50%, the residual monomers were removed through a precipitation in methanol. Then, the solid polymer powder was dissolved in acetone at the solid content of 25 wt % and the polymer solution was precipitated in sufficient MeOH again (MeOH×6 folds/3 times). The re-precipitated white powder samples were dried at 120° C. and 180° C. in a vacuum oven for 8 hours and 16 hours, respectively. The melt flow rate (MFR) of this polymer was measured at 0.5 g/10 minutes at 230 C/3.8 kg. The refractive index of the resulting polymer was measured at 1.490 at 589 nm.

The resulting polymer was confirmed using ¹H NMR and ¹³C NMR to possess the composition of pMMA/2-carboxyethyl acrylate (n=0-3)/SR218A (96.5/3.0/0.5 mol/mol/mol). The glass transition temperature of the copolymer resin was measured to be 124° C. in N₂ using DSC at the heating rate of 10° C./minute. The weight average molecular weight Mw of the resin was measured as 122,000 g/mole using GPC and MALS along with a Mw/Mn (polydispersity) value of 1.8. The light transmission from a 120 μm film was measured to be 92.2% at 560 nm using Lambda 950 while the haze was measured to be 0.4% using a hazemeter (Haze Gard Plus from BYK).

### Example 6 (pMMA Copolymer with 2-CEA and Isobornyl Acrylate)

pMMA-CEA-IBOA terpolymer was made from solution polymerization in toluene at 66° C.: This example demonstrates the preparation of a high molecular weight copolymer of methyl methacrylate and 2-carboxyethyl acrylate. 93.17 parts of methyl methacrylate, 5.69 parts of 2-carboxyethyl acrylate (2-CEA from Aldrich) and 1.14 parts of isobornyl acrylate (IBOA) (Sartomer) were charged into a reaction vessel containing 300 parts toluene near 23° C. with a mechanical stirring speed of 360 rpm. AIBN (from Aldrich) was used as an initiator at a level of 0.214_parts. The polymerization reaction occurred at 66° C. for 8 hours. When the conversion reached >50%, the residual monomers were removed through a precipitation in methanol. Then, the solid polymer powder was dissolved in acetone at the solid content of 25 wt % and the polymer solution was precipitated in sufficient MeOH again (MeOH×6 folds/3 times). The re-precipitated white powder samples were dried at 120° C. and 180° C. in a vacuum oven for 8 hours and 16 hours, respectively. The melt flow rate (MFR) of this polymer was measured at 1.2 g/10 minutes at 230 C/3.8 kg. The refractive index of the resulting polymer was measured at 1.490 at 589 nm.

The resulting polymer was confirmed using ¹H NMR and ¹³C NMR to possess the composition of pMMA/2-carboxyethyl acrylate (n=0-3)/IBOA (96.7/3.0/0.3 mol/mol/mol). The glass transition temperature of the copolymer resin was measured to be 121° C. in N₂ using DSC at the heating rate of 10° C./minute. The weight average molecular weight Mw of the resin was measured as 97,000 g/mole using GPC and MALS along with a Mw/Mn (polydispersity) value of 1.8. The light transmission from a 120 μm film was measured to be 92.2% at 560 nm using Lambda 950 while the haze was measured to be 0.4% using a hazemeter (Haze Gard Plus from BYK).

### Li-Ion Battery Cathode/Electrode Fabrications

### Cathode Slurry Preparations:

Polymer binders were dissolved in NMP in a sealed jar at the solid content of approximately 10 wt. % at 60° C. overnight at the rolling speed of approximately 100 rpm over a roller mixer. 1.0 part of conductive carbon powder, SuperP®Li (from Imerys) and 0.5 parts of TIMREX® KS6 Graphite (from Imerys) were added to 10 parts of a 10 wt. % binder solution, and then they were mixed using a planetary centrifugal mixer (Kakuhunter SK-300SII), for 5 minutes at 2000 rpm, along with air cooling stepwise. After the conductive carbon powder was fully dispersed in the binder solution, 47.5 parts of active material, LiNi_{0.5}Co_{0.2}Mn_{0.3}O₂ aka. NCM523 (Ronbay S-700), and a small fraction of NMP (5 parts) were added to the binder suspension, and was mixed to form a uniform black paste, typically for 5 minutes at 2000 rpm. In addition, another small fraction of NMP (2 parts) was added to the black paste and mixed for 60-120 seconds at 2000 rpm to reduce the slurry solid content and viscosity. This dilution step was repeated several times step by step until the slurry viscosity reached a target value suitable for coatings, typically in the range of 4,500-14,000 cP or mPas (Brookfield Viscometer, #63 spin@12 rpm). Generally speaking, the final solid ratio for NCM523/Super P/KS6/Binder was designed at 95/2/1/2 while the total solid content was targeted at around 59 wt. %.

### Coated NCM523 Cathode/Electrode:

The black cathode slurry was casted on a standard aluminum foil as a current collector (at the thickness of 16±0.5 μm) with an adjustable doctor blade on an automatic film applicator (JK-TMJ-200A made by JKNE) at a linear speed of 1.7 m/minute. The gap between the doctor blade and substrate was targeted at a dry thickness of 100±5 microns, along with the mass loading of 170±5 g/m². The wet coated sample was transferred to a convection oven, and dried at 110° C. for 120 minutes. After being dried, the electrode was calendared by using a roll mill (JK-GYJ-100A made by TMAXCN), the final density of a NCM523 based electrode is targeted around 3.4±0.1 g/cm³.

### Comparative Example 1 (Solef® 5130 from Solvay)

The cathode binder used was used with a battery-grade functional high molecular weight PVDF (Solef®5130-1001 from Solvay) dissolved in NMP. The cathode was prepared using a standard slurry procedure, and had a nominal composition of NCM523/SuperP/KS6/Binder=95/2/1/2 on a dry solid basis. The solution viscosity was measured at 8480 cP for the black slurry. The mass load of the cathodes was measured at 168 g/m² while the final compressed density was at 3.42 g/cm³. The functional Solef® binder exhibited 420N/m of the peel bonding adhesion over the Al foil in battery cathode binders using 180 degree peel adhesion tests.

### Comparative Example 2 (KYNAR®HSV900 from Arkema)

The cathode binder used was used with a battery-grade high molecular weight PVDF (KYNAR®HSV900 from Arkema) dissolved in NMP. The cathode was prepared using a standard slurry procedure, and had a nominal composition of NCM523/SuperP/KS6/Binder=95/2/1/2 on a dry solid basis. The solution viscosity was measured at 12600 cP for the black slurry. The mass load of the cathodes was measured at 172 g/m² while the final compressed density was at 3.33 g/cm³. The KYNAR®HSV900 binder exhibited 305 N/m of the peel bonding adhesion over the Al foil in battery cathode binders using a 180 degree peel adhesion testing method.

### Comparative Example 3 (5% Altuglas V-Grade pMMA Copolymer Blended with 95% KYNAR®HSV900)

The cathode binder used was based on the mixture of 95 wt % PVDF (KYNAR®HSV900 from Arkema) and 5 wt. % of pMMA/EA (99.5/0.5 mol/mol) (from Altuglas V-grade, Trinseo) through solution blending in NMP. The cathode was prepared using a standard slurry procedure, and had a nominal composition of NCM523/SuperP/KS6/Binder=95/2/1/2 on a dry solid basis. The solution viscosity was measured at 11900 cP for the black slurry. The mass load of the cathodes was measured at 175 g/m² and the final compressed density was around 3.42 g/cm³. The blended binder of 95 wt % KYNAR®HSV900 and 5 wt. % pMMA/EA (99.5/0.5 mol/mol) copolymer exhibited 280 N/m of the peel bonding adhesion over the Al foil in battery cathode binders using a 180 degree peel adhesion testing method against 305 N/m from a KYNAR® HSV900 binder.

The copolymer was confirmed using ¹H NMR to possess the composition of pMMA/EA (99.5/0.5 mol/mol). The glass transition temperature of the copolymer resin was measured to be 115° C. in N₂ using DSC at the heating rate of 10° C./minute. The weight average molecular weight Mw of the resin was measured as 84,000 g/mole using GPC and MALS along with a Mw/Mn (polydispersity) value of 1.9. The light transmission from a 120 μm film was measured to be 92.2% at 560 nm using Lambda 950 while the haze was measured to be 0.2% using a hazemeter (Haze Gard Plus from BYK).

### Comparative Example 4 (10% Altuglas V-Grade pMMA Copolymer Blended with 90% KYNAR®HSV900)

The cathode binder used was based on the mixture of 90 wt % PVDF (KYNAR®HSV900 from Arkema) and 10 wt. % of pMMA/EA (99.5/0.5 mol/mol) (from Altuglas V-grade, Trinseo) through solution blending in NMP. The cathode was prepared using a standard slurry procedure, and had a nominal composition of NCM523/SuperP/KS6/Binder=95/2/1/2 on a dry solid basis. The solution viscosity was measured at 10650 cP for the black slurry. The mass load of the cathodes was measured at 168 g/m² and the final compressed density was around 3.41 g/cm³. The blended binder of 90 wt % KYNAR®HSV900 and 10 wt. % pMMA/EA (99.5/0.5 mol/mol) copolymer exhibited 267 N/m of the peel bonding adhesion over the Al foil in battery cathode binders using a 180 degree peel adhesion testing method against 305 N/m from a KYNAR® HSV900 binder.

### Example 7 (5% Altuglas Functional pMMA Copolymer Containing 2-CEA Blended in 95% KYNAR®HSV900)

The cathode binder used was to mix 95 wt % PVDF (KYNAR®HSV900 from Arkema) with 5 wt % pMMA/2-carboxyethyl acrylate (n=0-3) (97.1/2.9 mol/mol) (from example 1) through solution blending in NMP. The cathode was prepared using a standard slurry procedure, and had a nominal composition of NCM523/SuperP/KS6/Binder=95/2/1/2 on a dry solid basis. The solution viscosity was measured at 12300 cP for the black slurry. The mass load of the cathodes was measured at 169 g/m² and the final compressed density was around 3.43 g/cm³. The blended binder of 95 wt % PVDF KYNAR®HSV900 and 5 wt. % pMMA/2-carboxyethyl acrylate n=0-3) (97.1/2.9 mol/mol) copolymer exhibited 415 N/m of the peel bonding adhesion over the Al foil in battery cathode binders using a 180 degree peel adhesion testing method against 305 N/m from a KYNAR® HSV900 binder.

### Example 8 (10% Altuglas Functional pMMA Copolymer Containing 2-CEA Blended in 90% KYNAR®HSV900)

The cathode binder used was to mix 10 wt % PVDF (KYNAR®HSV900 from Arkema) with 10 wt % pMMA/2-carboxyethyl acrylate (n=0-3) (97.1/2.9 mol/mol) (from example 1) through solution blending in NMP. The cathode was prepared using a standard slurry procedure, and had a nominal composition of NCM523/SuperP/KS6/Binder=95/2/1/2 on a dry solid basis. The solution viscosity was measured at 12250 cP for the black slurry. The mass load of the cathodes was measured at 166 g/m² and the final compressed density was around 3.51 g/cm³. The blended binder of 90 wt % PVDF KYNAR®HSV900 and 10 wt. % pMMA/2-carboxyethyl acrylate n=0-3) (97.1/2.9 mol/mol) copolymer exhibited 405 N/m of the peel bonding adhesion over the Al foil in battery cathode binders using a 180 degree peel adhesion testing method against 305 N/m from KYNAR®HSV900 control.

### Example 9 (5% Altuglas Functional pMMA Copolymer Containing 2-CEA Blended in 95% Functionalized Solef® 5130)

The cathode binder used was to mix 95 wt % functionalized PVDF (Solef®5130 from Solvay) with 5 wt % of pMMA/2-carboxyethyl acrylate (n=0-3) (97.1/2.9 mol/mol) (from example 1) through solution blending in NMP. The cathode was prepared using a standard slurry procedure, and had a nominal composition of NCM523/SuperP/KS6/Binder=95/2/1/2 on a dry solid basis. The solution viscosity was measured at 7880 cP for the black slurry. The mass load of the cathodes was measured at 165 g/m² and the final compressed density was around 3.53 g/cm³. The blended binder of 95 wt % functionalized PVDF (Solef® 5130 from Solvay) and 5 wt. % pMMA/2-carboxyethyl acrylate n=0-3) (97.1/2.9 mol/mol) copolymer exhibited 408 N/m of the peel bonding adhesion over the Al foil in battery cathode binders using a 180 degree peel adhesion testing method against 420 N/m from in a Solef® 5130 binder.

### Example 10 (5% Altuglas Functional pMMA Copolymer Containing 2-CEA Blended with 95% Solef®5130/KYNAR®HSV900 of 50:50 w/w)

The cathode binder used was to mix 95 wt. % PVDF containing Solef® 5130: KYNAR®HSV900 at the ratio of 50:50 by weight with 5 wt. % pMMA/2-carboxyethyl acrylate (n=0-3)/MAA (96.5/2.5/1.0 mol/mol/mol). (from example 4) through solution blending in NMP. The cathode was prepared using a standard slurry procedure, and had a nominal composition of NCM523/SuperP/KS6/Binder=95/2/1/2 on a dry solid basis. The solution viscosity was measured at 10900 cP for the black slurry. The mass load of the cathodes was measured at 175 g/m² and the final compressed density was around 3.50 g/cm³. The blended binder of 95 wt. % PVDF (Solef® 5130: KYNAR®HSV900 at the ratio of 50:50) and 5 wt. % pMMA/2-carboxyethyl acrylate (n=0-3)/MAA (96.5/2.5/1.0 mol/mol/mol). copolymer exhibited 417 N/m of the peel bonding adhesion over the Al foil in battery cathode binders using a 180 degree peel adhesion testing method.

### Example 11 (5% Altuglas Functional pMMA Copolymer Containing 2-CEA/SR218 Blended with 95% Solef®5130/KYNAR®HSV900 of 50:50 w/w)

The cathode binder used was to mix 95 wt % PVDF (95 wt. % PVDF containing Solef® 5130: KYNAR®HSV900 at the ratio of 50:50 by weight with 5 wt % pMMA/2-carboxyethyl acrylate (n=0-3)/SR218A (96.5/3.0/0.5 mol/mol/mol) (from example 5) through solution blending in NMP over a roller mixer. The cathode was prepared using a standard slurry procedure, and had a nominal composition of NCM523/SuperP/KS6/Binder=95/2/1/2 on a dry solid basis. The solution viscosity was measured at 10700 cP for the black slurry. The mass load of the cathodes was measured at 172 g/m² and the final compressed density was around 3.49 g/cm³. The blended binder of 95 wt % PVDF (Solef® 5130: KYNAR®HSV900 at the ratio of 50:50) and 5 wt. % pMMA/2-carboxyethyl acrylate (n=0-3)/SR218A (96.5/3.0/0.5 mol/mol/mol) copolymer exhibited 415 N/m of the peel bonding adhesion over the Al foil in battery cathode binders using a 180 degree peel adhesion testing method.

### Example 12 (5% Altuglas Acid-Functionalized pMMA Copolymer Blended with 95% KYNAR®HSV900)

The cathode binder used was to mix 95 wt % PVDF (KYNAR®HSV900 from Arkema) with 5 wt. % of pMMA/MAA/glutaric anhydride (95.1/3.8/1.1 mol/mol/mol) (from Altuglas, Trinseo) through solution blending in NMP over a roller mixer. The cathode was prepared using a standard slurry procedure, and had a nominal composition of NCM523/SuperP/KS6/Binder=95/2/1/2 on a dry solid basis. The solution viscosity was measured at 12300 cP for the black slurry. The mass load of the cathodes was measured at 170 g/m² and the final compressed density was around 3.43 g/cm³. The blended binder of 95 wt % PVDF KYNAR®HSV900 and 5 wt. % pMMA/methacylic acid/glutaric anhydride (95.1/3.8/1.1 mol/mol/mol) copolymer exhibited 396 N/m of peel bonding adhesion over the Al foil in battery cathode binders using a 180 degree peel adhesion testing method against 305 N/m from a KYNAR® HSV900 binder.

This example demonstrates the preparation of a high molecular weight copolymer with 4.8% methacrylic acid. 9480 parts of methyl methacrylate and 480 parts of methacrylic acid were charged into a reaction vessel near 0° C. under N₂ with a mechanical stirring speed of 100 rpm. In addition, Luperox® 531 (from Arkema) was used as an initiator at a level of 1.6 parts while 38 parts of n-dodecyl mercaptan (n-DDM from Aldrich) was used as a chain transfer agent, along with 1.0 part of di-tert-dodecyl disulfide (DtDDS from Arkema). The polymerization reaction occurred at 160° C. for 7 hours. When the conversion reached around 50%, the residual monomers were removed through a venting system. The resulting polymer was passed through a single-screw extruder at a die temperature of 240° C. while the barrel temperatures were at 230-250° C. The melt stream went through a water bath before the pelletization. Then the polymer was pelletized into 3-4 mm long pellets and dried at 100° C. in a convection oven for 8 hours. The melt flow rate of the polymer was measured to be 2.2 g/10 minutes at 230° C. under 3.8 kg. The refractive index of the resulting polymer was measured at 1.494 at 589 nm.

The resulting polymer was confirmed using ¹H NMR and ¹³C to possess the composition of pMMA/methacylic acid/glutaric anhydride (95.1/3.8/1.1 mol/mol/mol). The syndiotacticity of the copolymer was determined at 51% from the chemical shift of 44.5 ppm using ¹³C NMR while the isotaticity and atacticity were measured at 7% and 42% from 45.5 ppm and 45.0 ppm. The glass transition temperature of the resin was measured to be 121° C. in N₂ using DSC at the heating rate of 10° C./minute while the Vicat softening temperature was detected at 121° C. under 10N. The weight average molecular weight Mw of the resin was measured as being 85,000 g/mole using GPC and MALS along with a Mw/Mn (polydispersity) value of 1.9. The light transmission from a 3.2 mm plaque was measured to be 92.1% at 560 nm using Lambda 950 with a 150 mm integrating sphere while the haze was measured to be 0.5% using a hazemeter (Haze Gard Plus from BYK). The tensile modulus of the test sample was at 3.5 GPa while the tensile strength was at 73 MPa, along with a tensile elongation of 7%.

### Example 13 (10% Altuglas Acid-Functionalized pMMA Copolymer Blended with 90% KYNAR®HSV900)

The cathode binder used was to mix 90 wt % PVDF (KYNAR®HSV900 from Arkema) with 10 wt. % of pMMA/MAA/glutaric anhydride (95.1/3.8/1.1 mol/mol/mol) (from Altuglas, Trinseo) through solution blending in NMP over a roller mixer. The cathode was prepared using a standard slurry procedure, and had a nominal composition of NCM523/SuperP/KS6/Binder=95/2/1/2 on a dry solid basis. The solution viscosity was measured at 12280 cP for the black slurry. The mass load of the cathodes was measured at 167 g/m² and the final compressed density was around 3.50 g/cm³. The blended binder of 90 wt % PVDF KYNAR®HSV900 and 10 wt. % pMMA/MAA/glutaric anhydride (95.1/3.8/1.1 mol/mol/mol) terpolymer exhibited 391 N/m of peel bonding adhesion over the Al foil in battery cathode binders using a 180 degree peel adhesion testing method against 305 N/m from a KYNARR HSV900 binder.

### Example 14 (15% Altuglas Acid-Functionalized pMMA Copolymer Blended with 85% KYNAR®HSV900)

The cathode binder used was to mix 85 wt % PVDF (KYNAR®HSV900 from Arkema) with 15 wt. % of pMMA/MAA/glutaric anhydride (95.1/3.8/1.1 mol/mol/mol) (from Altuglas, Trinseo) through solution blending in NMP over a roller mixer. The cathode was prepared using a standard slurry procedure, and had a nominal composition of NCM523/SuperP/KS6/Binder=95/2/1/2 on a dry solid basis. The solution viscosity was measured at 11560 cP for the black slurry. The mass load of the cathodes was measured at 171 g/m² and the final compressed density was around 3.51 g/cm³. The blended binder of 85 wt % PVDF KYNAR®HSV900 and 15 wt. % pMMA/MAA/glutaric anhydride (95.1/3.8/1.1 mol/mol/mol) terpolymer exhibited 386 N/m of peel bonding adhesion over the Al foil in battery cathode binders using a 180 degree peel adhesion testing method against 305 N/m from a KYNAR® HSV900 binder.

### Example 15 (5% Altuglas Acid-Functional pMMA Copolymer Blended with 95% PVDF Containing Solef® 5130/KYNAR®HSV900 of 50:50 w/w)

The cathode binder used was to mix 95 wt. % PVDF containing Solef®5130: KYNAR®HSV900 at the ratio of 50:50 by weight) with 5 wt. % pMMA/MAA/glutaric anhydride (95.1/3.8/1.1 mol/mol/mol) through solution blending in NMP over a roller mixer. The cathode was prepared using a standard slurry procedure, and had a nominal composition of NCM523/SuperP/KS6/Binder=95/2/1/2 on a dry solid basis. The solution viscosity was measured at 10200 cP for the black slurry. The mass load of the cathodes was measured at 175 g/m² and the final compressed density was around 3.49 g/cm³. The blended binder of 95 wt. % PVDF (containing Solef® 5130: KYNAR®HSV900 at the ratio of 50:50) and 5 wt. % pMMA/MAA/glutaric anhydride(95.1/3.8/1.1 mol/mol/mol) terpolymer exhibited 416 N/m of the peel bonding adhesion over the Al foil in battery cathode binders using a 180 degree peel adhesion testing method.

### Example 16 (5% Altuglas Amphiphilic pMMA Copolymer Blended with 95% PVDF Containing Solef®5130/KYNAR®HSV900 of 50:50 w/w)

The cathode binder used was to mix 95 wt. % PVDF containing Solef®5130: KYNAR®HSV900 at the ratio of 50:50 (by weight) with 5 wt. % pMMA/tert-butyl cyclohexyl methacrylate/methacylic acid/glutaric anhydride (95.6/1.2/3/0.2 mol/mol/mol). tetrapolymer through solution blending in NMP over a roller mixer. The cathode was prepared using a standard slurry procedure, and had a nominal composition of NCM523/SuperP/KS6/Binder=95/2/1/2 on a dry solid basis. The solution viscosity was measured at 10450 cP for the black slurry. The mass load of the cathodes was measured at 173 g/m² and the final compressed density was around 3.48 g/cm³. The blended binder of 95 wt. % PVDF (containing Solef®5130: KYNAR®HSV900 at the ratio of 50:50) and 5 wt. % pMMA/tert-butyl cyclohexyl methacrylate/methacylic acid/glutaric anhydride (95.6/1.2/3/0.2 mol/mol/mol). tetrapolymer exhibited 418 N/m of the peel bonding adhesion over the Al foil in battery cathode binders using a 180 degree peel adhesion testing method.

This example demonstrates the preparation of a high molecular weight copolymer of methyl methacrylate, methacrylic acid (MAA), and tert-butyl cyclohexyl methacrylate (having a 75% trans/25% cis isomer ratio). 9416 parts of methyl methacrylate, 400 parts of methacrylic acid, and 150 parts of tert-butyl cyclohexyl methacrylate were charged in to a reaction vessel near 0° C. under N₂ with a mechanical stirring speed of 100 rpm. In addition, Luperox® 531 (from Arkema) was used as an initiator at a level of 1.6 parts while 32 parts of n-dodecyl mercaptan (n-DDM from Aldrich) was used as a chain transfer agent, along with 1.0 part of di-tert-dodecyl disulfide (DtDDS from Arkema). The polymerization reaction occurred at 160° C. for 7 hours. When the conversion reached around 52%, the residual monomers were removed through a venting system. The resulting copolymer was passed through a single-screw extruder at a die temperature of 230-240° C. while the barrel temperatures were at 230-245° C. The melt stream went through a water bath before the pelletization. Then the polymer was pelletized into 3-4 mm long pellets and dried at 100° C. in a convection oven for 8 hours. The melt flow rate of the polymer was measured to be 1.4 g/10 minutes at 230° C. under 3.8 kg. The refractive index of the resulting polymer was measured at 1.491 at 589 nm.

The resulting polymer was confirmed using ¹H NMR and ¹³C NMR to possess the composition of pMMA/tert-butyl cyclohexyl methacrylate/methacylic acid/glutaric anhydride (95.6/1.2/3/0.2 mol/mol/mol). The syndiotacticity of the copolymer was determined at 51% from the chemical shift of 44.5 ppm using ¹³C NMR while the isotaticity and atacticity were measured at 7% and 42% from 45.5 ppm and 45.0 ppm. The glass transition temperature of the resin was measured to be 122° C. in N₂ using DSC at the heating rate of 10° C./minute while the Vicat temperature was detected at 123° C. under 10N. The weight average molecular weight Mw of the resin was measured as being 100,000 g/mole using GPC and MALS along with a Mw/Mn (polydispersity) value of 1.9. The light transmission from a 3.2 mm plaque was measured to be 91.9% at 560 nm using Lambda 950 with a 150 mm integrating sphere while the haze was measured to be 0.9% using a hazemeter (Haze Gard Plus from BYK). The tensile modulus of the test sample was at 3.3 GPa while the tensile strength was at 75 MPa, along with a tensile elongation of 10%.

What is claimed is:

1. An acrylic copolymer composition, wherein said acrylic copolymer comprises:
a) one or more (meth)acrylic monomer units;
b) 2-carboxyethyl acrylate (CEA) and/or (meth)acrylic acid (MAA or AA) hydrophilic monomer units;
c) optionally one or more hydrophobic monomer units; and
d) optionally one or more hydrophilic monomer units different from b).

2. The acrylic copolymer composition of claim 1, wherein the CEA monomer units comprise from 0.5 to 10 weight percent, preferably 1 wt. % to 7 wt. % of the acrylic copolymer.

3. The acrylic copolymer composition of claim 1, wherein said (meth)acrylic monomer units comprise from 75 to 99 wt % of the acrylic copolymer.

4. The acrylic copolymer composition of claim 1, wherein said acrylic copolymer comprises from 0.1 to 10 wt percent of one or more (alkyl)₁₋₄ (meth)acrylate units as part of the one or more (meth)acrylic monomer units.

5. The acrylic copolymer composition of claim 1, wherein said hydrophobic monomer units comprise from 0.2 to 10, and preferably from 0.5 to 5 weight percent of the acrylic copolymer.

6. The acrylic copolymer composition of claim 1, wherein said hydrophobic monomer units are selected from the group consisting of tert-butyl cyclohexyl (meth)acrylate, 3,3,5-trimethyl cyclohexyl(meth)acrylate, isobornyl methyl acrylate (IBOMA), and isobornyl acrylate (IBOA).

7. The acrylic copolymer composition of claim 1, wherein said acrylic copolymer has a Tg of from 110° C. to 140° C., preferably from 115° C. to 135° C., more preferably from 115° C. to 130° C., and more preferably from 120° C. to 130° C.

8. The acrylic copolymer composition of claim 1, wherein the weight average molecular weight of the copolymer is greater than 65,000 g/mol, preferably greater than 80,000 g/mol, more preferably greater than 100,000 g/mol, much more preferably greater than 120,000 g/mol.

9. The acrylic copolymer composition of claim 1, wherein said one or more additives are selected from the group consisting of fillers, surface modifying additives, antioxidants, UV screens, processing aids, fibers, lubricant agents, heat stabilizers, flame retardants, synergists, impact modifiers, pigments and other coloring agents, lithium nickel cobalt manganese oxide (LiNiCoMnO₂), carbon black, graphite sheets, graphite flakes and radical scavenging agents.

10. The acrylic copolymer composition of claim 9, wherein said composition comprises one or more impact modifiers as an additive.

11. The acrylic copolymer composition of claim 10, wherein said impact modifiers comprise from 5 wt. % to 50 wt. % of said acrylic copolymer composition.

12. The acrylic copolymer composition of claim 1, wherein said composition further comprises one or more polymers compatible with said acrylic copolymer.

13. The acrylic copolymer composition of claim 12, wherein said compatible polymers are one or more polyvinylidene fluoride polymers, preferably polyvinylidene fluoride homopolymers or polyvinylidene fluoride copolymers.

14. The acrylic copolymer composition of claim 13, where the copolymer composition is a PMMA copolymer blend with a polyvinylidene fluoride polymer, preferably a high molecular weight polyvinylidene fluoride polymer, wherein 5 to 25 weight percent of polyvinylidene fluoride polymer have been replaced with PMMA.

15. An article comprising the acrylic copolymer composition of claim 1, wherein said article is selected from the group consisting of batteries, composites, glass-/carbon-fiber re-enforced composites, water filtration membranes, optical lenses, extruded films, laminates, (co-)extruded sheets/profiles, automotive front lenses, lighting pipes, optical protection films in reflective signage, and home appliances.

16. The article of claim 15 wherein said acrylic copolymer composition is part of a binder for a battery, preferably for a binder for a cathode, and/or separator coatings in said battery, preferably a lithium ion battery.

17. The article of claim 16, wherein said acrylic copolymer composition is blended with a high molecular weight polyvinylidene fluoride polymer.

18. The article of claim 17, wherein said acrylic copolymer composition is blended with a high molecular weight polyvinylidene fluoride polymer, said blend preferably comprising 2 wt. % to 25 wt % of the acrylic copolymer, and more preferably 5 wt % to 20 wt. %.

19. A method for improving bonding adhesion strength of PVDF in a cathode binder by at least 1.2 times, preferably by at least 1.3 time, more preferably by at least 1.4 times, where the method comprises replacing 5-25 wt % of the PVDF with pMMA.

20. A method for reducing slurry viscosity of PVDF in a cathode binder by at least 10%, preferably by at least 20%, where the method comprises replacing 5-25 wt % of the PVDF with pMMA.
